(19) United States
(12) Patent Application Publication
(10) Pub. No.: US 2007/0212509 A1
(43) Pub. Date: Sep. 13, 2007

(54) Adhesive cutout

(76) Inventors: David N. Herbig, Bellevue, WA (US); Christopher A. Smith, Issaquah, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/716,083

(22) Filed: Mar. 8, 2007

Related U.S. Application Data
(60) Provisional application No. 60/780,312, filed on Mar. 8, 2006.

(51) Int. Cl. B32B 33/00

(52) U.S. Cl. 428/40.1

(57) ABSTRACT

An adhesive cutout includes an adhesive layer having a first surface and an opposing second surface, the first and the second surfaces at least partially covered by a first release liner and a second release liner, respectively. The first release liner includes first removal means for facilitating removal of the first release liner from the first surface of the adhesive layer. The second release liner includes second removal means for facilitating removal of the second release liner from the second surface of the adhesive layer.

### CROSS-REFERENCE TO RELATED APPLICATION

This application claims the benefit under 35 U.S.C. § 119(e) of U.S. Provisional Patent Application No. 60/780,312 filed Mar. 8, 2006, where this provisional application is incorporated herein by reference in its entirety.

### BACKGROUND OF THE INVENTION

1. Field of the Invention

This disclosure generally relates to adhesive media, and more particularly, to an adhesive cutout for adhering an object to another object.

2. Description of the Related Art

Objects, such as emblem media including, but not limited to, security badges, police badges, work badges, ski tickets, nametags, pictures, logos, identification media and/or youth group badges or any other object that a user may desire to affix to another object, are typically sewn or conventionally mounted onto a target object, such as, but not limited to, clothing, luggage, walls, computer monitors, vehicle interior and exterior surfaces, cup-holders, purses, frames, refrigerators, decals, coasters, greeting cards, gifts, mirrors, data media cases, file folders, books, wallets and/or any other surface upon which it is desirable to affix an object. However, sewing and conventional mounting, such as mechanical fasteners, picture frames, liquid and tape adhesives, and/or magnets, can be time-consuming, expensive and messy, and, when emblems are removed, can damage the target object and/or the emblem, reducing the ability to re-use the emblem and/or the target object. Other methods for carrying an emblem, such as identification tags, by an object, such as clothing, luggage, purses, file folders and/or any other surface upon which it is desirable to affix an object, include suspending the tag by plastic or elastic bands from the object. However, such suspension methods are susceptible to damage and failure under conditions such as those during loading and unloading luggage from airplanes, working and moving excessively while wearing a badge, and repetitively using objects such as purses and file folders carrying the suspended identification tags.

Furthermore, in International Publication No. WO 2005/105442, it has been proposed to use adhesive sheets to adhere various emblems on garments. Although the use of adhesives reduces obstacles associated with sewing, it introduces new problems. For example, since the adhesive sheet includes a backing, once the emblem is attached to a surface of the adhesive sheet, it is difficult and time-consuming to remove the backing prior to applying the emblem to the garment.

### BRIEF SUMMARY OF THE INVENTION

In one embodiment, an adhesive cutout for applying a first object to a second object includes an adhesive layer comprising a first surface and a second surface, a first release liner at least partially covering the first surface of the adhesive layer and comprising means for facilitating removal of the first release liner from the adhesive layer, and a second release liner at least partially covering the second surface of the adhesive layer and comprising means for facilitating removal of the second release liner from the adhesive layer.

In one embodiment, an adhesive cutout for applying a first object to a second object includes a first adhesive layer, a second adhesive layer, a substrate interposed between the first adhesive layer and the second adhesive layer, the substrate having a first surface and a second surface, a first release liner covering at least a portion of the first adhesive layer, the first release liner having first removal means for facilitating removal of the first release liner from the first adhesive layer, and a second release liner covering at least a portion of the second adhesive layer, the second release liner having second removal means for facilitating removal of the second release liner from the second adhesive layer.

In one embodiment, a method of adhering a first object to a second object using an adhesive cutout includes removing a first release liner via a means for facilitating removal of the first release liner from an adhesive layer, exposing at least a portion of a first surface of the adhesive layer, applying a surface of the first object to the first surface of the adhesive layer, removing a second release liner via a means for facilitating removal of the second release liner from the adhesive layer, exposing at least a portion of the second surface of the adhesive layer, and applying the second surface of the adhesive layer to the second object.

In one embodiment, a method of making an adhesive cutout for applying a first object to a second object includes interposing an adhesive layer between a first release liner and a second release liner, forming first removal means on the first release liner to facilitate removal of the first release liner from the adhesive layer, and forming second removal means on the second release liner to facilitate removal of the second release liner from the adhesive layer.

In one embodiment, an adhesive blank includes an adhesive layer interposed between a first release liner and a second release liner, and a plurality of adhesive cutouts formed in the adhesive layer and the first and the second release liners. Each adhesive cutout includes first removal means for facilitating removal of the first release liner from the adhesive layer, and second removal means for facilitating removal of the second release liner from the adhesive layer.

In one embodiment, a manufactured roll comprises an adhesive layer interposed between a first release liner and a second release liner for forming a plurality of adhesive sheets, each adhesive sheet including at least one adhesive cutout, each adhesive cutout including first removal means for facilitating removal of the first release liner from the adhesive layer, and second removal means for facilitating removal of the second release liner from the adhesive layer.

### BRIEF DESCRIPTION OF THE SEVERAL VIEWS OF THE DRAWING(S)

In the drawings, the sizes and relative positions of elements are not necessarily drawn to scale. For example, the shapes of various elements and angles are not drawn to scale, and some of the elements are arbitrarily enlarged and positioned to improve drawing legibility. Further, the particular shapes of the elements, as drawn, are not intended to convey any information regarding the actual shape of the particular elements, and have been solely selected for ease of recognition in the drawings.

FIG. 1A is a front view of an adhesive cutout according to one embodiment.

FIG. 1B is a cross-sectional view of the adhesive cutout of FIG. 1A, taken along section line 1B-1B.

FIG. 1C is another cross-sectional view of the adhesive cutout of FIG. 1A, taken along section line 1C-1C.

FIG. 2 is an exploded perspective view of the adhesive cutout of FIG. 1A.

FIG. 3 is a perspective view of the adhesive cutout of FIG. 1A.

FIG. 4 is a perspective view of an object being applied to the adhesive cutout of FIG. 1A.

FIG. 5 is a perspective view of the adhesive cutout of FIG. 4 attached to the object.

FIG. 6 is a front view of an adhesive cutout according to another embodiment.

FIG. 7 is an exploded perspective view of the adhesive cutout of FIG. 6.

FIG. 8 is a front view of an adhesive cutout according to yet another embodiment.

FIG. 9 is an exploded perspective view of the adhesive cutout of FIG. 8.

FIG. 10 is a partial perspective view of a roll comprising a plurality of adhesive cutouts according to still another embodiment.

FIG. 11 is an exploded perspective view of an adhesive blank according to a further embodiment.

FIG. 12A is a front view of an adhesive cutout according to yet a further embodiment.

FIG. 12B is a cross-sectional view of the adhesive cutout of FIG. 12A, taken along section line 12B-12B.

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description, certain specific details are set forth in order to provide a thorough understanding of various embodiments. However, one skilled in the art will understand that the embodiments may be practiced without these details. In other instances, well-known structures associated with adhesives, substrates, such as, but not limited to, release liners, and automated equipment, such as, but not limited to, printing presses and die cutting machinery, have not been described in detail to avoid unnecessarily obscuring the descriptions of the embodiments.

Unless the context requires otherwise, throughout the specification and claims which follow, the word “comprise” and variations thereof, such as “comprises” and “comprising” are to be construed in an open sense, that is as “including, but not limited to.”

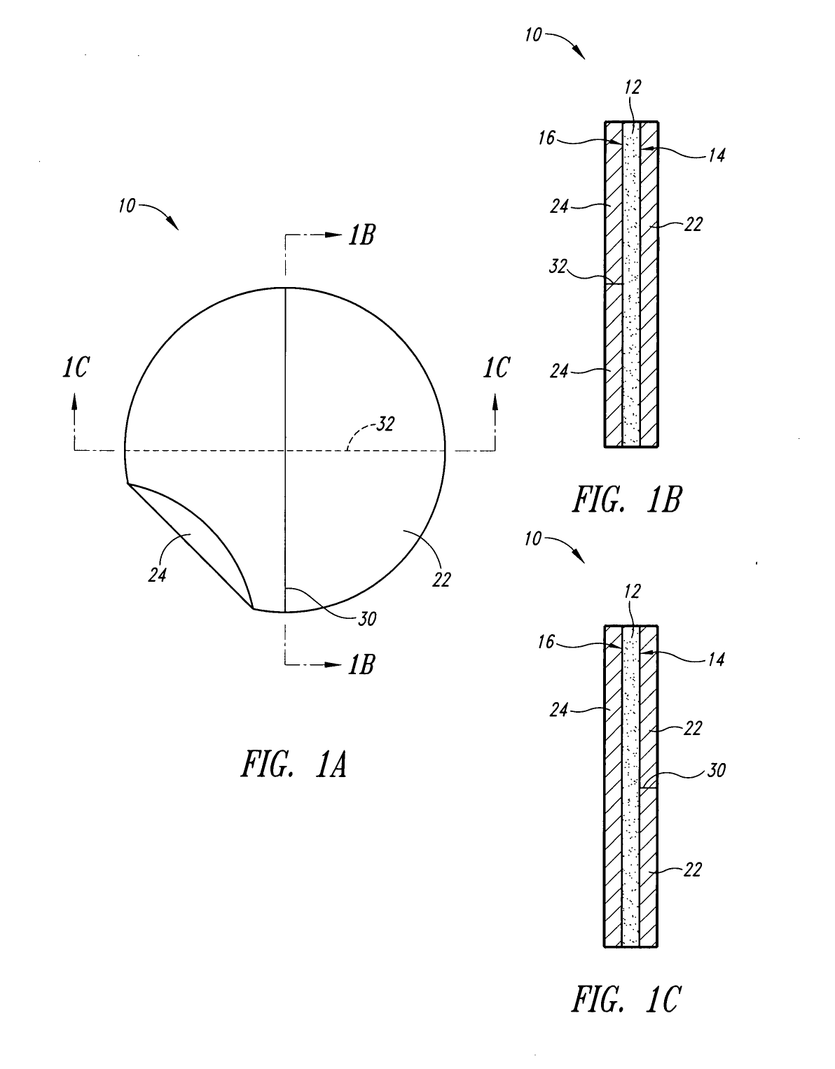

FIGS. 1A-1C illustrate one embodiment, in which an adhesive cutout 10 comprises an adhesive layer 12 having a first surface 14 and a second surface 16 opposed to the first surface 14. The first and the second surfaces 14, 16 are at least partially covered by a first release liner 22 and a second release liner 24, respectively. The first release liner 22 includes at least a first structure 30 to facilitate removal of the first release liner 22, and the second release liner 24 includes at least a second structure 32 to facilitate removal of the second release liner 24, from the first and the second surfaces 14, 16 of the adhesive layer 12, respectively.

The first and the second structures 30, 32 may comprise a through structural discontinuity and/or a surface structural discontinuity. Examples of a through structural discontinuity include splits, perforations, scoring or spaced incisions, a plurality of cuts, intermittent slits, an extended tear or cut through a portion of the first and the second release liners 22, 24, a breach of the first and the second release liners 22, 24 extending from one edge to another edge of the release liners 22, 24, any combination thereof, and/or any partial, intermittent or total breach, severance, and/or discontinuity that penetrates a surface of the first and the second release liners 22, 24 and extends through at least a portion of a thickness of the first and the second release liners 22, 24. Examples of a surface structural discontinuity include folds, creases, furrows, indentations, grooves, channels, wrinkles, ridges, any combination thereof, and/or any partial, intermittent or elongated surface discontinuity that does not penetrate the surface of the first and the second release liners 22, 24. The surface structural discontinuity may extend along a portion of the first and the second release liners 22, 24, or from one edge to another edge of the first and the second release liners 22, 24. The first and the second release liners 22, 24 may employ different types of structures to facilitate the removal thereof in some embodiments.

The structures 30, 32 that include the through structural discontinuity may be formed by various methods including scoring, punching, piercing, perforating, cutting, tearing, puncturing and/or any other method that causes a penetration of the first and the second release liners 22, 24. The structures 30, 32 that include the surface structural discontinuity may also be formed by various methods including folding, pressing, punching, creasing, and/or any other method that intentionally alters a surface continuity of the first and the second release liners 22, 24.

In the illustrated embodiment of FIG. 1A, the structures 30, 32 are linear however, the structures 30, 32 may take any shape, such as, but not limited to, a curvilinear shape. The structures 30, 32 may be in a form of a closed shape, such as a circle or an ellipse. In the illustrated embodiment of FIG. 1, the structures 30, 32 intersect at a substantially right angle; however, any configuration may be possible. For example, the structures 30, 32 may be parallel and offset, or they may intersect at an angle different from a right angle. In some embodiments, similar to the embodiment illustrated in FIG. 1, the structures 30, 32 would normally not be directly aligned.

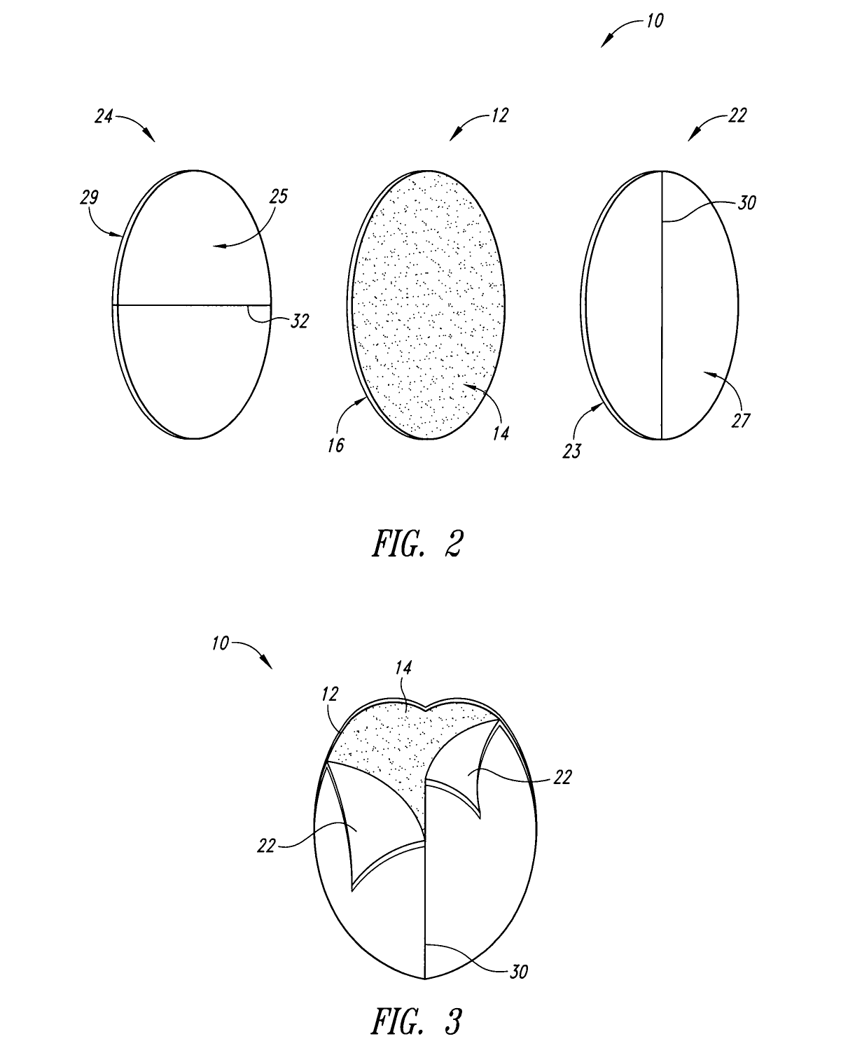

Referring to FIG. 2, the release liners 22, 24 may be made of any material such that a first surface 23 of the first release liner 22 and a first surface 25 of the second release liner 24, facing the adhesive layer 12, will adhere to the adhesive layer 12 but can be easily removed to expose at least a portion of the adhesive layer 12. The first release liner 22 includes a second surface 27 opposed to the first surface 23, and the second release liner 24 includes a second surface 29 opposed to the first surface 25. In some embodiments, at least one of the surfaces 23, 25, 27, 29 of the release liners 22, 24, can be printed on. Suitable materials for the release liners 22, 24 include a paper that is silicon-impregnated or coated on at least the first surfaces 23, 25. When the silicon-impregnated paper is used, the concentration of silicon on the first surfaces 23, 25 of the first and the second release liners 22, 24 may be such that a substantial portion of the adhesive layer 12 will not remain adhered to the release liners 22, 24 when removed.

The adhesive cutout 10, or a portion thereof such as at least one of the release liners 22, 24 carrying the adhesive layer 12, may be formed from pre-manufactured rolls of a silicon-impregnated paper with adhesive coating. At least one of the second surfaces 27, 29 of the respective release liners 22, 24 can include a glossy finish to facilitate unrolling of the pre-manufactured rolls prior to, during and/or after manufacturing of the adhesive cutout 10.

As illustrated in FIG. 3, manipulating the adhesive cutout 10 proximate the first structure 30, facilitates at least partially separating the first release liner 22 from the adhesive layer 12. A user may then pull on the separated portions to remove the first release liner 22 and expose at least a portion of the first surface 14 of the adhesive layer 12.

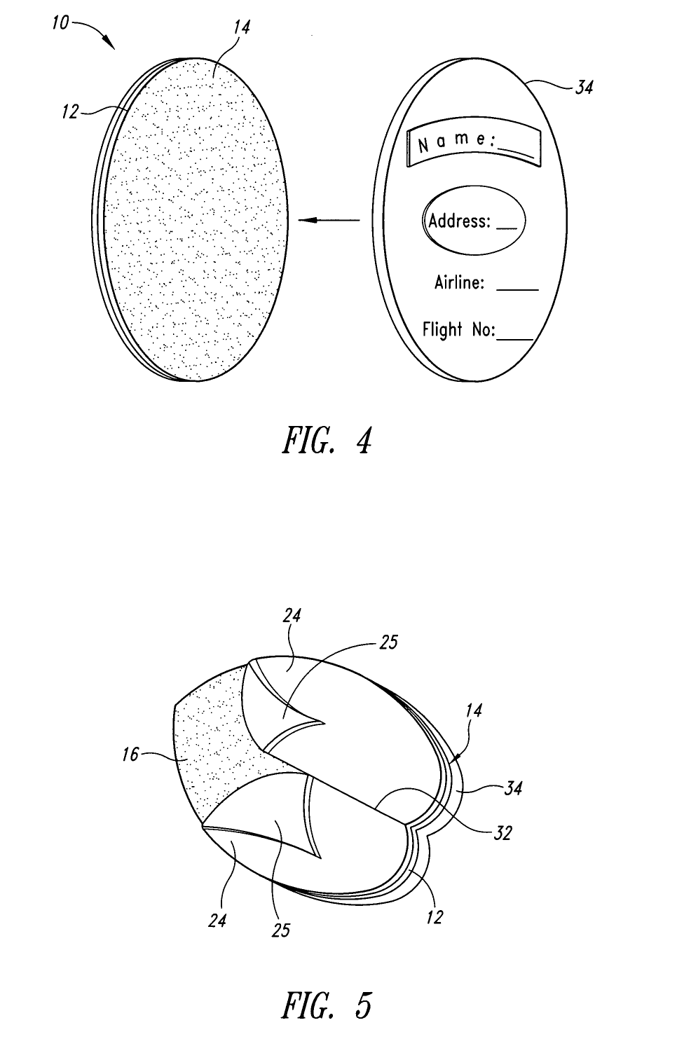

As illustrated in FIG. 4, an emblem 34, such as an identification media can adhere to the adhesive cutout 10 on the first surface 14 of the adhesive layer 12. The adhesive layer 12 can comprise any suitable adhesive, for example, a reinforced acrylic adhesive or a pressure sensitive adhesive. In some embodiments, the adhesive can be non-toxic. Some adhesives, such as reinforced acrylic adhesive, may benefit from application of heat to set the adhesive after the emblem 34 is affixed to an object, such as, but not limited to, clothing, luggage, walls, computer monitors, vehicle interior and exterior surfaces, cup-holders, purses, frames, refrigerators, coasters, greeting cards, gifts, mirrors, data media cases, file folders, books, wallets and/or any other surface upon which it is desirable to affix an object.

The adhesive layer 12 may include a dissolvable adhesive, which would facilitate reuse of the emblem 34 and the target object, such as, but not limited to, clothing, luggage, walls, computer monitors, vehicle interior and exterior surfaces, cup-holders, purses, frames, refrigerators, decals, coasters, greeting cards, gifts, mirrors, data media cases, file folders, books, wallets and/or any other surface upon which it is desirable to affix an object. For example, reinforced acrylic adhesive dissolves when exposed to dry-cleaning fluid and other solvents, such as WD-40. Hence, the emblem 34 may be removed by either dry-cleaning the target object or by exposing the target object to a solvent. In addition, or instead, a thermoplastic, if used in the adhesive layer 12, can be reheated to facilitate removal of the emblem 34.

As illustrated in FIG. 5, once the emblem 34 adheres to the first surface 14 of the adhesive layer 12, the adhesive cutout 10 may then be manipulated proximate the second structure 32. Manipulating the adhesive cutout 10 proximate the second structure 32 facilitates at least partially separating the second release liner 24 from the adhesive layer 12. A user may then pull on the separated portions to remove the second release liner 24 and expose at least a portion of the second surface 16 of the adhesive layer 12. The user may next apply the emblem 34 to the target object by adhering the second surface 16 onto the target object, such as, but not limited to, clothing, luggage, walls, computer monitors, vehicle interior and exterior surfaces, cup-holders, purses, frames, refrigerators, decals, coasters, greeting cards, gifts, mirrors, data media cases, file folders, books, wallets and/or any other surface upon which it is desirable to affix an object.

In applications where the adhesive layer 12 benefits from heat, the heat may be supplied by means such as, but not limited to, irons, blow-dryers or clothes dryers, or any combination thereof or any other device or method that can supply heat to the target object. Furthermore, the first surface 25 of the release liner 24 may be silicon-impregnated or coated to facilitate most or all of the adhesive layer 12 remaining adhered to the emblem 34 while the release liner 24 is removed.

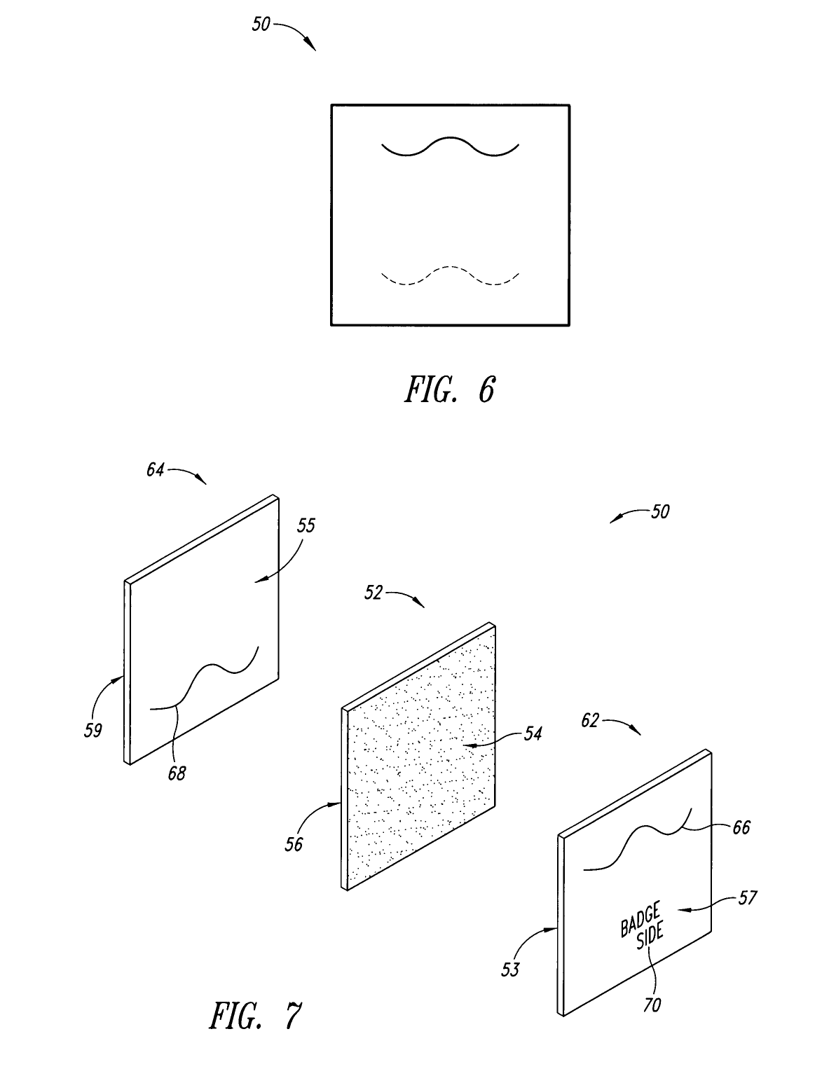

In the illustrated embodiment of FIGS. 1-5, the adhesive cutout 10 is circular; however, other embodiments are possible, including, but not limited to, a rectangular adhesive cutout 50 as illustrated in FIGS. 6 and 7.

As illustrated in FIG. 7, the adhesive cutout 50 comprises an adhesive layer 52 comprising a first surface 54 and a second surface 56. The adhesive cutout 50 further comprises a first release liner 62 and a second release liner 64, each comprising at least one structure to facilitate removal of the release liners 62, 64 from the adhesive layer 52. The first release liner 62 comprises a first structure 66 to facilitate a removal of the first release liner 62 and the second release liner 64 comprises a second structure 68 to facilitate a removal of the second release liner 64. In this embodiment, the structures 66, 68 comprise a curvilinear separation. The first release liner 62 includes a first surface 53 and a second surface 55 opposed to the first surface 53. Similarly, the second release liner 64 includes a first surface 57 and a second surface 59 opposed to the first surface 57. At least one of the surfaces 53, 55, 57, 59 of at least one of the release liners 62, 64 may comprise optional printing or writing 70. The printing may for example include instructions, identifying marks, a schematic or picture of an associated emblem, and/or advertisements and/or any other indicia desired.

The structures 66, 68 need not extend the entire span of the release liners 62, 64. Rather they can extend partially across the respective release liners 62, 64 with their length sufficient to facilitate removing the release liners 62, 64 from the adhesive layer 52 by manipulating the adhesive cutout 50 proximate the structures 66, 68. In other embodiments, one of the structures 66, 68 can extend partially across while the other of the structures 66, 68 extends from one edge to another edge of the respective release liners 62, 64. In yet other embodiments, both structures 66, 68 may respectively extend from an edge to another edge of the release liners 62, 64.

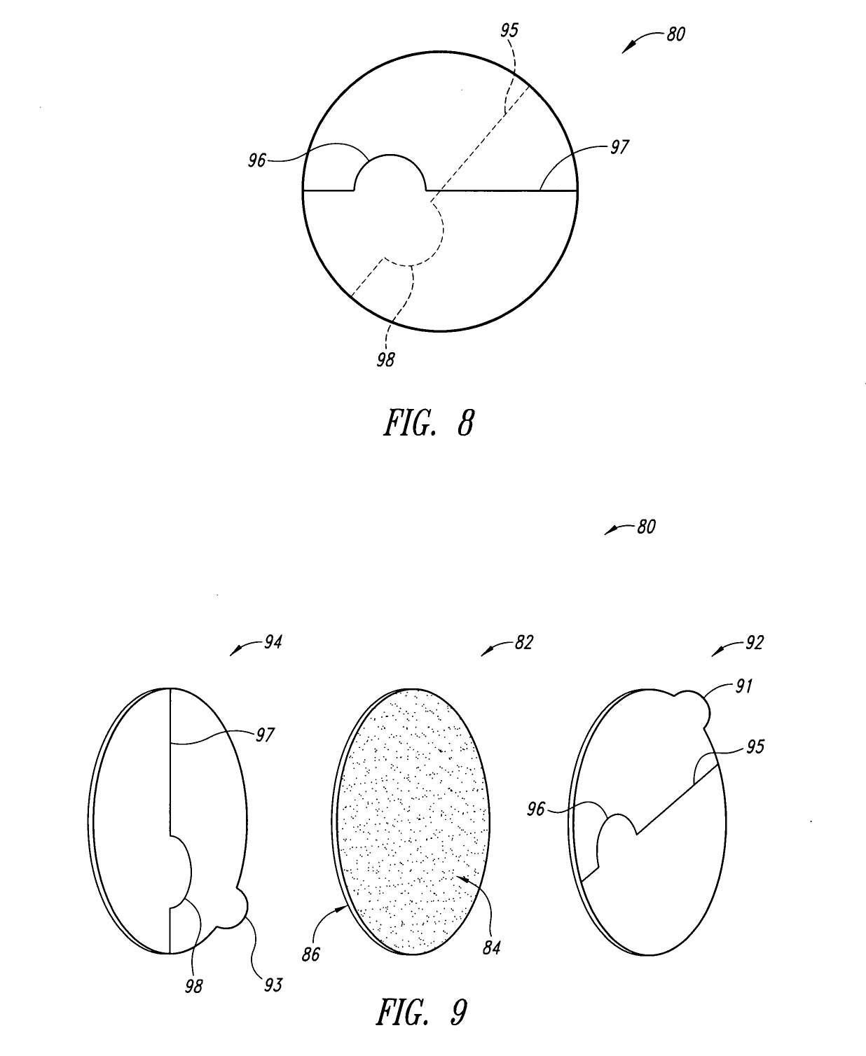

FIGS. 8 and 9 illustrate yet another embodiment, in which an adhesive cutout 80 comprises an adhesive layer 82 comprising a first surface 84 and a second surface 86. The adhesive cutout 80 further comprises a first release liner 92 substantially protecting the first surface 84 and a second release liner 94 substantially protecting the second surface 86. Furthermore, the first release liner 92 comprises a first structure 95 and a first tab 96 to facilitate a removal of the first release liner 92. The second release liner 94 comprises a second structure 97 and a second tab 98 to facilitate a removal of the second release liner 94. At least a portion of the first and the second tabs 96, 98 may be formed on or proximate the first and the second structures 95, 97, respectively, making it easier to remove the first and the second release liners 92, 94 upon manipulation of the adhesive cutout 80 proximate the first and the second structures 95, 97, respectively.

An individual of ordinary skill in the art having reviewed this disclosure will appreciate these and other variations that can be made to various structures for removing the release liners 62, 64 from the adhesive layer 52. For example, as illustrated in FIG. 9, the first release liner 92 may further comprise an optional third tab 91 and the second release 94 liner may further comprise an optional fourth tab 93, the third and fourth tabs 91, 93 extending from at least a portion of a periphery of the first and the second release liners 92, 94, respectively. The tabs 91, 93, 96, 98 may comprise a tab, a flag, a recession, a flap and/or any other feature or appendage flagging a manipulable portion of the first and the second release liners 92, 94 and operable to facilitate removal of the first and the second release liners 92, 94. Additionally, or alternatively, the tabs 91, 93, 96, 98 may be formed by overlapping at least a portion of one of the first and the second release liners 92, 94 and at least a portion of the other of the first and the second release liners 92, 94.

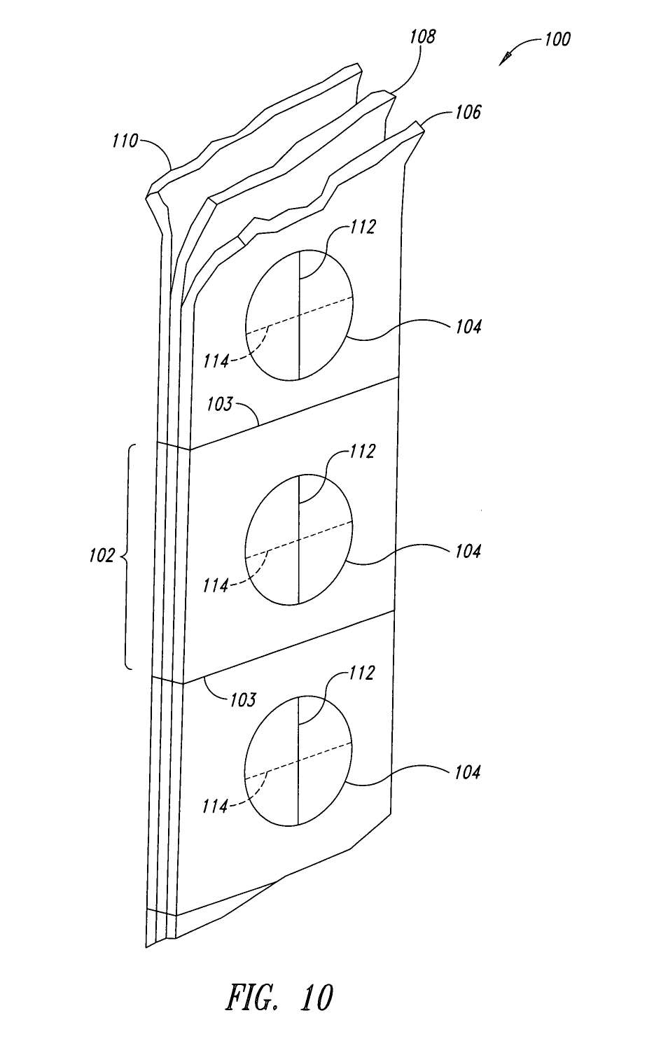

FIG. 10 illustrates still another embodiment, in which a pre-manufactured roll 100 comprises sheets 102, each sheet 102 comprising at least one adhesive cutout 104. The rolls 100 may be formed from pre-manufactured rolls 100 that comprise a first release liner 106, which can be a silicon-impregnated paper, and an adhesive layer 108 comprising a first surface adjacent the first release liner 106. The adhesive layer 108 may be in a form of a coating. In the same or in a separate manufacturing process, a second release liner 110 is provided adjacent a second surface of the adhesive layer 108. Alternatively, the rolls 100 may include the adhesive layer 108 interposed between the first and the second release liners 106, 110.

In the same or in a separate manufacturing process, the adhesive cutouts 104 are formed in the sheets 102 of the rolls 100. In the same or in a different manufacturing process, a first structure 112 is formed in the first release liner 106 to facilitate a removal of the first release liner 106. In the same or in a different manufacturing process, a second structure 114 is formed in the second release liner 110 to facilitate a removal of the second release liner 110. The structures 112, 114 may include a through structural discontinuity and/or a surface structural discontinuity.

The roll 100 may optionally comprise dividing structures 103 positioned between the sheets 102 and formed in at least one of the first and the second release liners 106, 110 to distinguish and facilitate a separation of each sheet 102 from adjacent sheets 102. The dividing structures 103 may include a through structural discontinuity and/or a surface structural discontinuity. Examples of a through structural discontinuity include splits, perforations, scoring or spaced incisions, a plurality of cuts, intermittent slits, an extended tear or cut through a portion of the sheets 102, a breach of the sheets 102 extending from one edge to another edge of each sheet 102, any combination thereof, and/or any partial, intermittent or total breach, severance, and/or discontinuity that penetrates a surface of the sheets 102 and extends through at least a portion of a thickness of the sheets 102. Examples of a surface structural discontinuity include folds, creases, furrows, indentations, grooves, channels, wrinkles, ridges, any combination thereof, and/or any partial, intermittent or elongated surface discontinuity that does not penetrate, but intentionally alters a continuity of a surface of the sheets 102. The surface structural discontinuity may extend along a portion of the sheets 102, or from one edge to another edge of the sheets 102.

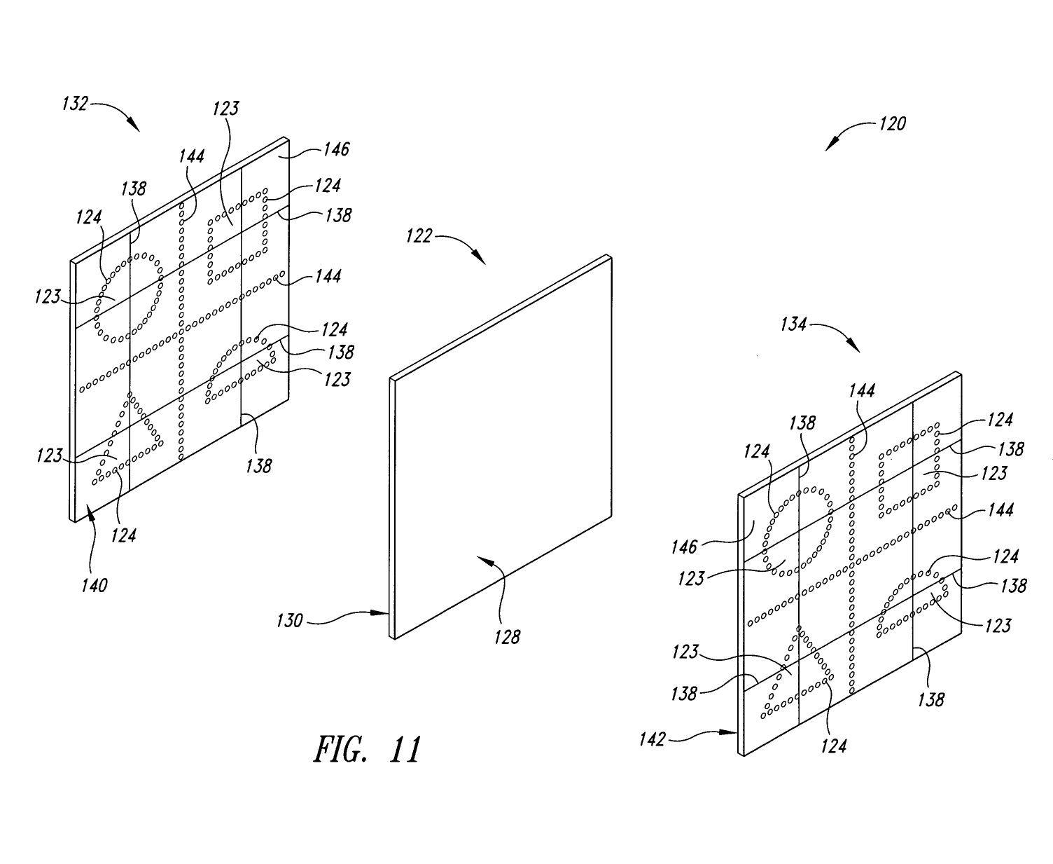

FIG. 11 illustrates a further embodiment, in which an adhesive blank 120 comprises an adhesive layer 122 having a first surface 128 and a second surface 130 opposed to the first surface 128. The adhesive blank 120 may be formed from pre-manufactured rolls of a silicon-impregnated paper with adhesive coating. The adhesive blank 120 further comprises a first release liner 132 and a second release liner 134. In the same or in a separate manufacturing process, the first and the second release liners 132, 134 are removably adhered to the first and the second surfaces 128, 130 of the adhesive layer 122, respectively. A plurality of adhesive cutouts 123 may be formed in the adhesive blank 120.

The plurality of adhesive cutouts 123 may form similar or different shapes. Furthermore, an optional outline structure 124 formed in the adhesive blank 120 facilitates a separation of the adhesive cutouts 123 from the adhesive blank 120. The outline structure 124 may include a through structural discontinuity and a surface structural discontinuity. Examples of a through structural discontinuity include splits, perforations, scoring or spaced incisions, a plurality of cuts, intermittent slits, an extended tear or cut, any combination thereof, and/or any partial, intermittent or total breach, severance, and/or discontinuity that penetrates a surface of the adhesive cutouts 123 and extends through at least a portion of a thickness of the adhesive cutouts 123.

Examples of a surface structural discontinuity include folds, creases, furrows, indentations, grooves, channels, wrinkles, ridges, any combination thereof, and/or any partial, intermittent or elongated surface discontinuity that does not penetrate, but intentionally alters a continuity of a surface of the adhesive cutouts 123.

In the same or in a separate manufacturing process, the release liners 132, 134 may receive a structure 138 that promotes at least partially removing the release liners 132, 134 from the adhesive layer 122 prior to use. The structure 138 may include a through structural discontinuity and/or a surface structural discontinuity to facilitate removal of the first and the second release liners 132, 134.

The first and the second release liners 132, 134 may be made of any material such that respective first surfaces 140, 142 of the first and the second release liners 132, 134, facing the adhesive layer 122, will adhere to the adhesive layer 122, but can be easily removed to expose at least a portion of the first and the second surfaces 128, 130 of the adhesive layer 122. Suitable materials for the release liners 132, 134 include a paper that is silicon-impregnated on at least one of the first surfaces 140, 142.

It is understood that production of the adhesive blank 120 may exclude some of the acts discussed herein, or include additional acts. For example, the adhesive blank 120 may be manufactured without the outline structure 124 for applications such as those where the desired shape is not known at a time of purchase. A cutting device, such as scissors, can be used to form an adhesive cutout of any shape.

Additionally, or alternatively, the release liners 132, 134 may receive optional separation structures 144 between portions of the adhesive blank 120, each portion typically comprising at least one adhesive cutout 123. The separation structures 144 may include a through structural discontinuity and/or a surface structural discontinuity to facilitate separating the adhesive cutouts 123, the separated adhesive cutout 123 including a surrounding excess material 146. The excess material 146 protects edges of the adhesive cutouts 123 prior to use. The adhesive cutouts 123 with the excess material 146 may be used in applications such as, but not limited to, retail outlets purchasing the adhesive blanks 120 in bulk and separating the adhesive cutouts 123, with the excess material 146, and individually reselling them.

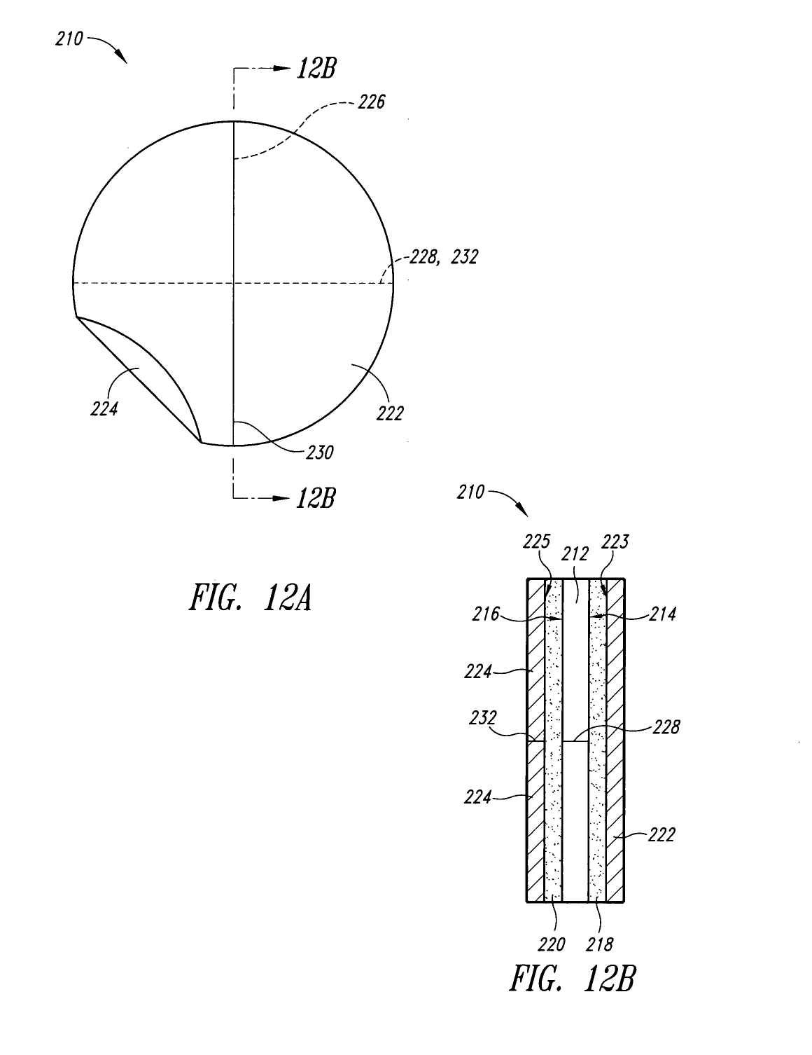

FIGS. 12A and 12B illustrate yet a further embodiment of an adhesive cutout 210. The adhesive cutout 210 comprises a substrate 212, which may be made of any suitable material, for example, a silicon-impregnated paper, such as a kraft release liner with a silicon-coated polypropylene. The substrate 212 comprises a first surface 214 and a second surface 216 opposed to the first surface 214. The first and the second surfaces 214, 216 respectively comprise a first adhesive layer 218 and a second adhesive layer 220. The first and the second adhesive layers 218, 220 are at least partially covered by a first release liner 222 and a second release liner 224, respectively.

The first and the second adhesive layers 218, 220 may comprise a same type of adhesive. Alternatively, the first and the second adhesive layers 218, 220 may comprise different types of adhesives to suit various applications. For example, in an application comprising adhering a first and a second object together using the adhesive cutout 210, the first object may better adhere to a heat-activated adhesive while the second object may better adhere to a pressure-sensitive adhesive. In such an application, the first adhesive layer 218 may comprise a heat-activated adhesive while the second adhesive layer 220 may comprise a pressure-sensitive adhesive. Similarly, in the same or in a different application, the first object may be more porous than the second object, and thus two different types of adhesives may be employed. In such an application, the first adhesive layer 218 may comprise an adhesive suitable for use with a porous object, while the second adhesive layer 220 may comprise an adhesive suitable for use with a less porous object.

As another example, it may be desired to permanently adhere the first object to the first surface 214 while temporarily and/or removably adhering the second object to the second surface 216 of the substrate 212. In such an application, the first adhesive layer 218 may comprise a stronger and/or more permanent adhesive while the second adhesive layer 220 may comprise a weaker and/or more temporary adhesive. One of skill in the art having reviewed this disclosure can appreciate these and other modifications that can be made to the adhesive cutout 210.

The first surface 214 of the substrate 212 may comprise an optional first structure 226 and the second surface 216 of the substrate 212 may comprise an optional second structure 228. The first structure 226 facilitates folding of the adhesive cutout 210 in at least a first direction. The second structure 228 facilitates folding of the adhesive cutout 210 in at least a second direction. The first and the second structures 226, 228 may include a through structural discontinuity and/or a surface structural discontinuity.

In the illustrated embodiment of FIG. 12A, the first and the second structures 226, 228 are linearly formed; however, they may take any shape, such as, but not limited to, a curvilinear shape. In the illustrated embodiment of FIG. 12A, the structures 226, 228 intersect at a substantially right angle; however, any configuration may be possible. For example, the first and the second structures 226, 228 may be parallel and off set, or they may intersect at an angle different from a right angle.

Furthermore, the first and the second release liners 222, 224 comprise at least a first structure 230 and a second structure 232, respectively, to facilitate removing the first and the second release liners 222, 224 from the adhesive layers 218, 220. The first and second structures 230, 232 to facilitate removal of the release liners 222, 224 may substantially coincide with the first and the second structures 226, 228 of the substrate 212. The first and the second structures 230, 232 of the first and the second release liners 222, 224, respectively, may include a through structural discontinuity and/or a surface structural discontinuity at least partially extending across the first and the second release liners 222, 224.

Folding the adhesive cutout 210 about the first and the second structures 226, 228 of the substrate 212 further facilitates the removal of the first and the second release liners 222, 224, respectively. For example, folding the adhesive cutout 210 about the first structure 226 of the substrate 212, such that a portion of the first release liner 222 collapses toward another portion thereof, will induce a tension or a stretching of the second structure 232 of the second release liner 224 and further facilitates the removal of the second release liner 224. Similarly, folding the adhesive cutout 210 about the second structure 228 of the substrate 212, such that a portion of the second release liner 224 collapses toward another portion thereof, will induce a tension or a stretching of the first structure 230 of the first release liner 222 and further facilitates the removal of the first release liner 222.

The first and the second release liners 222, 224 may be fabricated from any material such that respective first surfaces 223, 225 of the first and second release liners 222, 224, facing the substrate 212, will adhere to the adhesive layers 218, 220, but can be easily removed to expose at least a portion of the adhesive layers 218, 220 (FIG. 12B). The first release liner 222 includes a second surface 227 opposed to the first surface 223 and the second release liner 224 includes a second surface 229 opposed to the first surface 223. In some embodiments, one or more of the surfaces 223, 225, 227, 229 of the first and the second release liners 222, 224, can be printed on. The operation of applying the adhesive cutout 210 is similar to the operation of the other embodiments described herein.

From the foregoing it will be appreciated that embodiments of an adhesive cutout may be used to removably or permanently couple any two objects having a surface. Examples may include removably attaching pictures to any structure, removably securing handheld electronics to an interior portion of a vehicle, removably affixing business cards to computer monitors or other structure, permanently attaching labels to file folders, or attaching decals to any surface, such as in vehicular and aircraft applications, or any other application in which removably or permanently attaching two objects is desired.

Furthermore, after reviewing the specification, one of skill in the art will realize that adhesive cutouts similar to the adhesive cutouts described herein and/or adhesive blanks similar to the adhesive blanks described herein may be sold separately or may be sold together with objects such as, but not limited to, badges, emblems, luggage identification media or pictures or any other object the adherence of which to another object may be desired. Additionally, or alternatively, the adhesive cutouts and/or the adhesive blanks can be sold as a part of a kit that also includes objects, such as emblems, decals, badges, luggage identification media and/or pictures, to be adhered to other objects, such as clothing, luggage, walls, computer monitors, vehicle interior and exterior surfaces, cup-holders, purses, frames, refrigerators, coasters, greeting cards, gifts, mirrors, data media cases, file folders, books, wallets and/or any other surface upon which it is desirable to affix an object.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments have been described herein for purposes of illustration, various modifications may be made without deviating from the spirit and scope of the invention. Accordingly, the invention is not limited except as by the appended claims and their equivalents.

1. An adhesive cutout for applying a first object to a second object, comprising:
an adhesive layer comprising a first surface and a second surface;
a first release liner at least partially covering the first surface of the adhesive layer and comprising means for facilitating removal of the first release liner from the adhesive layer; and
a second release liner at least partially covering the second surface of the adhesive layer and comprising means for facilitating removal of the second release liner from the adhesive layer.

2. The adhesive cutout of claim 1 wherein the means for facilitating the removal of the first release liner comprises a first structure formed in the first release liner and the means for facilitating the removal of the second release liner comprises a second structure formed in the second release liner.

3. The adhesive cutout of claim 2 wherein the first structure and the second structure each have a curvilinear shape.

4. The adhesive cutout of claim 2 wherein the first structure and the second structure intersect one another.

5. The adhesive cutout of claim 4 wherein the intersection of the first structure and the second structure forms a right angle.

6. The adhesive cutout of claim 2 wherein the first structure and the second structure each comprise at least one of a through structural discontinuity or a surface structural discontinuity.

7. The adhesive cutout of claim 2 wherein the means for facilitating the removal of the first release liner further comprises at least a first tab extending from the first release liner and the means for facilitating the removal of the second release liner further comprises at least a second tab extending from the second release liner.

8. The adhesive cutout of claim 7 wherein the first tab is formed on at least a portion of the first structure and the second tab is formed on at least a portion of a second structure.

9. The adhesive cutout of claim 7 wherein the first tab extends from at least a portion of a periphery of the first release liner, and the second tab extends from at least a portion of a periphery of the second release liner.

10. The adhesive cutout of claim 2 wherein the first structure extends partially across the first release liner and the second structure extends at least partially across the second release liner.

11. The adhesive cutout of claim 1 wherein the first release liner comprises an at least partially glossy surface and the second release liner comprises at least one surface adapted to carry indicia.

12. The adhesive cutout of claim 1 wherein the adhesive layer comprises a reinforced acrylic adhesive.

13. The adhesive cutout of claim 1 wherein at least one of the first and second release liners comprises a silicon-coated polypropylene.

14. The adhesive cutout of claim 1 wherein the adhesive layer comprises an adhesive that can be dissolved by a solvent.

15. The adhesive cutout of claim 1 wherein the first object is a badge and the second object is a garment.

16. An adhesive cutout for applying a first object to a second object, comprising:
a first adhesive layer;
a second adhesive layer;
a substrate interposed between the first adhesive layer and the second adhesive layer, the substrate having a first surface and a second surface;
a first release liner covering at least a portion of the first adhesive layer, the first release liner comprising first removal means for facilitating removal of the first release liner from the first adhesive layer; and
a second release liner covering at least a portion of the second adhesive layer, the second release liner comprising second removal means for facilitating removal of the second release liner from the second adhesive layer.

17. The adhesive cutout of claim 16 wherein the first adhesive layer comprises a first type of adhesive and the second adhesive layer comprises a second type of adhesive.

18. The adhesive cutout of claim 16 wherein the substrate includes a first structure formed in the first surface of the substrate to facilitate a folding of the adhesive cutout in a first direction, and a second structure formed in the second surface of the substrate to facilitate a folding of the adhesive cutout in a second direction.

19. The adhesive cutout of claim 16 wherein the first and the second removal means each comprise at least one of a perforation, a cut, a score, or a tear.

20. A method of adhering a first object to a second object using an adhesive cutout, the method comprising:
removing a first release liner via a means for facilitating removal of the first release liner from an adhesive layer, exposing at least a portion of a first surface of the adhesive layer;
applying a surface of the first object to the first surface of the adhesive layer;
removing a second release liner via a means for facilitating removal of the second release liner from the adhesive layer, exposing at least a portion of the second surface of the adhesive layer; and
applying the second surface of the adhesive layer to the second object.

21. The method of claim 20, further comprising applying heat to set the adhesive layer.

22. A method of making an adhesive cutout for applying a first object to a second object, comprising:
interposing an adhesive layer between a first release liner and a second release liner;
forming first removal means on the first release liner to facilitate removal of the first release liner from the adhesive layer; and
forming second removal means on the second release liner to facilitate removal of the second release liner from the adhesive layer.

23. The method of claim 22 wherein forming the first removal means and forming the second removal means comprises forming at least one of a through structural discontinuity or a surface structural discontinuity in the first and the second release liners, respectively.

24. The method of claim 23, further comprising:
providing at least a first tab on the first release liner to further facilitate the removal of the first release liner from the adhesive layer; and
providing at least a second tab on the second release liner to further facilitate the removal of the second release liner from the adhesive layer.

25. The method of claim 22, further comprising forming the adhesive layer and at least one of the first or the second release liners from pre-manufactured rolls of a silicon-impregnated paper having an adhesive coating.

26. An adhesive blank, comprising:
an adhesive layer interposed between a first release liner and a second release liner; and
a plurality of adhesive cutouts formed in the adhesive layer and the first and the second release liners, each adhesive cutout comprising:
first removal means for facilitating removal of the first release liner from the adhesive layer; and
second removal means for facilitating removal of the second release liner from the adhesive layer.

27. The adhesive blank of claim 26 wherein the first removal means comprises a first structure formed in the first release liner and the second removal means comprises a second structure formed in the second release liner.

28. The adhesive blank of claim 26, further comprising at least one of a through structural discontinuity and a surface structural discontinuity dividing the adhesive blank into separable portions wherein each separable portion comprises at least one adhesive cutout.

29. A manufactured roll, comprising:
an adhesive layer interposed between a first release liner and a second release liner for forming a plurality of adhesive sheets, each adhesive sheet including at least one adhesive cutout, each adhesive cutout comprising:
first removal means for facilitating removal of the first release liner from the adhesive layer; and
second removal means for facilitating removal of the second release liner from the adhesive layer.

30. The manufactured roll of claim 29, further comprising:
a plurality of dividing structures, each dividing structure formed between adjacent adhesive sheets and configured to facilitate separation of each adhesive sheet from adhesive sheets adjacent thereto.
